(19) United States
(12) Patent Application Publication
(10) Pub. No.: US 2016/0103885 A1
(43) Pub. Date: Apr. 14, 2016

(54) SYSTEM FOR, AND METHOD OF, BUILDING A TAXONOMY

(71) Applicant: WorkDigital Limited, London (GB)

(72) Inventors: Howard S. LEE, Borehamwood (GB); William A. FISCHER, London (GB); Simon HAMMOND, London (GB)

(21) Appl. No.: 14/705,042

(22) Filed: May 6, 2015

(30) Foreign Application Priority Data
Oct. 10, 2014 (GB) 1418017.8

(51) Int. Cl. G06F 17/30; G06F 17/27

(52) U.S. Cl. CPC G06F 17/30539; G06F 17/277; G06F 17/30705; G06F 17/30663

(57) ABSTRACT

A taxonomy is built by associating metadata with search terms. A body of data records is analyzed to identify pairs of search terms co-occurring in individual data records and to obtain an observed measure of the frequency of such co-occurrences between identified pairs. A taxonomy is then built by constructing metadata and associating the search terms with respective metadata, the metadata for each co-occurring search term identifying at least one other search term with which it co-occurs, together with a measure of relatedness based on the observed co-occurrence frequency measure between the co-occurring pair.

The present invention relates to a system for, and method of, building a taxonomy for use with a search engine, and to a search engine comprising the taxonomy. It finds particular application in searching bodies of unstructured or partially unstructured data.

It is known to search unstructured or partially unstructured data sources for specified information. For example, in recruitment it is known to search a body of curricula vitae (CVs) or profiles in order to find individuals who have the right skills to perform a job. Social networks such as Facebook, Twitter, and LinkedIn give access to CVs and profiles which incorporate information about the skills and interests of potential job candidates. There are now over a billion people whose CVs and profiles are publicly available for searching. However, known computational tools cannot sift and rank even the tens of thousands of CVs or profiles of people who appear to have relevant skills for a job vacancy. It is a real challenge to generate well-targeted search results from a large body of unstructured data sources.

Using a search strategy based on selected keywords has in the past required experience and knowledge, including regarding developing language usage. Many domains are problematic in several ways. Remaining with the recruitment example, sifting involves identifying whether individuals have a skill and to what degree. Looking first at possession of a skill, profiles and CVs typically include the job titles an individual has had in the past, and their current job title. It is known to use job titles to determine whether an individual has a skill, using the job title as a proxy (or keyword). For example, if one is searching for someone with experience in finance and Excel, one might search for the Job Title “Accountant”. However, there is very little parity from company to company about what a job title represents and so it is an inexact proxy. Companies use different products and so an accountant at one company might have different skills and knowledge from an accountant at another company. It is possible to use a domain expert to create keywords that can be used for sifting but it can require considerable knowledge of a domain and therefore probably more than one expert if more than one domain is to be covered.

Looking secondly at depth of knowledge in a skill, it is known to look at the number of times a relevant term, such as MySQL or Hadoop, appears in the CV or profile. However, this is not a good measure of depth of knowledge and can be “gamed” by job seekers who simply increase the number of mentions of a relevant term. It is also known to look at length of service with a specified job title, it being assumed the individual exercised a named skill throughout the length of service. However, that skill might in fact have only been used on one recent or high profile project.

Lastly, in general, CVs and profiles may be incomplete or unclear. Desired skills may not be mentioned and skills in newly developing areas may be difficult to relate to existing domains.

According to embodiments of the invention in a first aspect, there is provided a method of building a taxonomy by associating metadata with search terms, wherein the method comprises the steps of:
a) analysing a body of data records to identify pairs of search terms co-occurring in individual data records and to obtain an observed measure of the frequency of such co-occurrences between identified pairs; and
b) building a taxonomy by constructing metadata and associating the search terms with respective metadata, the metadata for each co-occurring search term identifying at least one other search term with which it co-occurs, together with a measure of relatedness based on the observed co-occurrence frequency measure between the co-occurring pair.

Such a method can identify significantly related content in data records of a body of data records and a taxonomy exploiting the related content can be built without necessarily relying on the input of an expert. A search engine using such a taxonomy to sift and rank unstructured documents can return considerably improved search results. The structure of such taxonomies can also offer an efficient source of effective search strategies, potentially saving resources in terms of both creating the search strategy and achieving a search result.

Preferably the body of data records comprises unstructured documents and the step of analysing them might include lexical and/or heuristic analysis. The method can then be used to build and/or update a taxonomy from unstructured documents which may have been created for other purposes. For example, a taxonomy intended for use in recruitment, where the search terms might comprise skill terms, might be built or updated by processing CVs, user profiles and/or job advertisements. This allows the taxonomy to be kept up to date with current skills and use of language.

Although described herein primarily in the field of recruitment, embodiments of the invention can be used in many different domains, including for example fault diagnosis in relation to a machine. A diagnostic tool might use a taxonomy built according to an embodiment of the invention to prioritise repair strategies based on relevant and up to date solutions identified in unstructured documents, for example available from more than one technical forum.

The construction of metadata in step b) may comprise:
c) normalising the observed co-occurrence frequency measure with respect to an expected frequency measure, based on overall frequency of occurrence of the respective search terms, to obtain the measure of relatedness.

The step of building the taxonomy may comprise:
d) building at least two clusters of search terms, each search term in a cluster having a non-zero measure of relatedness to at least one other search term in the cluster;
e) labelling the clusters; and
f) using the search terms from the clusters to create a first layer of the taxonomy and using the labels of the clusters to create a second layer.

A taxonomy built in this way is embodied as search terms associated with metadata, the metadata for each search term including at least one non-zero measure of relatedness and the metadata as a whole defining the taxonomy structure. This two-layer taxonomy structure lends itself particularly well to deriving a search strategy based on the taxonomy since the search strategy may comprise a set of relatively strongly related search terms from a cluster, plus the cluster label. Deriving a search strategy can be done quickly with little processing time compared with for example the use of a binary tree structure because associations from a search term to appropriately related search terms is direct rather than in multiple steps. Here again, an operator devising a search strategy need have little or no expertise in the domain of the search terms.

Each measure of the frequency of co-occurrences might for example be the number of data records in which there is co-occurrence. Similarly, the overall frequency of occurrence might be the number of data records in which a search term occurs.

Many taxonomies will find close equivalents of a search term, such as a miss-spelling or an acronym, but embodiments of the invention in its first aspect support a taxonomy based on relationships between search terms which can be drawn from usage. Using such a taxonomy, a search using a target search term can identify data records which do not include that target search term, either itself or in any close equivalent form, but do include at least one different search term showing a degree of relatedness to the first search term by usage. In recruitment for example, where a recruiter is reviewing CVs in relation to a job advertisement, rather than having to match specific skills on a CV to a vacancy, a recruiter can simply search for front-end developers, or PHP developers, and the search facility will produce relevant results. Furthermore, the taxonomy may identify, for example, that Zend is related to PHP, while a recruiter might not.

It is known in lexical analysis to derive a canonical form for every search term, to which variations can be related. In this context, “different search term” in relation to another search term means one assigned to a different canonical form.

The taxonomy might be used in combination with a search engine to search a body of data records and embodiments of the invention include a search engine comprising the taxonomy. It is possible that the searched body of data records is also used to build or update the taxonomy. Each body of data records (information in an electronic form) will usually comprise data records expected to contain relevant search terms, such as job advertisements, CVs and profiles for a taxonomy for use in recruitment.

A significant advantage of embodiments of the invention is that a taxonomy can potentially be partially or entirely data-driven, without unnecessary introduction of limitations, subjective or otherwise. Rather than requiring an expert to produce a taxonomy from scratch, with their own limited experience and individual biases, their role can be just to approve a proposal or select between a small number of variations. This has the effect of making the taxonomy more objective and efficient to derive. Common variations of a term only need to be recognised rather than imagined. The taxonomy can optionally be built based entirely on the content of a first body of data records. This will reflect the nature of that body of data records. The taxonomy can automatically reflect current usage and relatedness of the search terms and can do it across any domain without the help of an expert. As time goes by, the taxonomy can be updated or extended very simply by adding fresh data records, for instance from those of a second body of data records that it is being used to search. As new search terms come into usage, their relatedness to other terms can be calculated automatically and used to place them in the taxonomy.

Embodiments of the invention are not limited to building a taxonomy having only two layers. Further layers may be created in similar fashion, for example where there are multiple cluster labels in the second layer. These cluster labels may themselves be assembled into clusters for a third layer and so on. However, for searching efficiency, what is often required is a relatively “flat” taxonomy tree, having perhaps only two, three or possibly four layers. Embodiments of the invention can be used flexibly to create a tree having a desired number of layers.

The method described above may further comprise the step of applying a threshold value for the measure of relatedness such that search terms having only co-occurrences for which the measure of relatedness is below the threshold value are disregarded. Disregarded search terms are not deleted from the taxonomy but temporarily disregarded in relation to building clusters or other outputs based on the taxonomy. Such a thresholding step gives control over cluster size and potentially the number of layers in the taxonomy and can conveniently be carried out by an operator viewing a screen view on a graphical user interface (GUI), showing a representation of the cluster(s).

An important step is labelling the clusters. This can be done automatically, for example using the search term in a cluster that most frequently occurs in the body of data records. Alternatively, there might be human input at this point, to add, choose or modify a label.

Advantages of embodiments of the invention can be seen in the recruitment example mentioned above. By using the taxonomy, it becomes possible to identify people with relevant skill sets even where they have not mentioned a skill in their CV or profile explicitly. This is possible where they have mentioned a skill that belongs to the same cluster of search terms because the taxonomy can be used to locate data records via the cluster label and/or related search terms. In an example of this, if the taxonomy is being used to find a developer for a mobile “app” (application for a mobile device), a chosen search term might be “mobile application development experience”. If that appears on a CV then that search could be effective but the CV might instead refer to experience with “objective-c” or “cocoa”. These are both native programming languages for building mobile apps. An embodiment of the invention is likely to have identified these languages as search terms and automatically related them in a cluster to the search term “mobile application development experience”. A search based on the taxonomy could then find the individuals with “objective-c” and/or “cocoa” even though their CV didn't explicitly state “mobile application development experience”.

In many search scenarios, the data records are unstructured or partially unstructured. That is, they are wholly, or contain, a block of text. This applies in recruitment. CVs, job ads and profiles are generally written by individuals without a framework of rules or menus as to words or forms to use, or specified fields to fill. This can lead to problems in selecting search terms which take into account, for example, mis-spelling, aliases/synonyms, acronyms and internationalised forms. It is therefore preferable that the step of analysing the body of data records comprises lexical analysis of the body of data records so as to achieve a canonical form for each search term, to which variations can be related. Each canonical form might be automatically generated but optionally subject to approval or modification by a user such as a domain expert.

The lexical analysis may comprise identifying search terms in different categories, for example supported by a lookup process. This can be useful in bringing additional information to bear on search results. For example, the different categories might comprise any two or more of skill terms, organisations (companies and/or educational establishments), job title, name or geographical significance. Although a primary category such as skill terms might be subject to all the steps b) to f), search terms in other categories may simply be identified and stored, or only made subject for example to steps b) and c) to obtain a measure of relatedness. In a recruitment example, company names might be used to refine search results based on skill terms in a document record (for example a CV or user profile) by weighting search results according to the presence of one or more company names having a significant measure of relatedness to a specified company name, such as the name of a company for which recruitment is being done.

According to embodiments of the invention in a second aspect, there is provided a system for building a taxonomy comprising metadata associated with search terms, wherein the system comprises:
A) a co-occurrence detector for analysing a body of data records to identify pairs of search terms co-occurring in individual data records and to obtain an observed measure of the frequency of such co-occurrences between identified pairs; and
B) a metadata generator for creating associated metadata for each co-occurring search term identified by the co-occurrence detector, the metadata identifying at least one other search term with which it co-occurs, together with a measure of relatedness based on the observed co-occurrence frequency measure between the co-occurring pair.

The metadata generator may be configured to normalise the observed co-occurrence frequency measure with respect to an expected frequency measure, based on overall frequency of occurrence of the respective search terms, to obtain the measure of relatedness.

The system for building a taxonomy may comprise further components as set out in the claims, and/or configured to provide steps of a method according to embodiments of the invention in its first aspect.

According to embodiments of the invention in a third aspect, there is provided a method of searching data records by use of a taxonomy comprising search terms having associated respective metadata wherein, for each search term, the metadata includes a measure of relatedness based on co-occurrences of search terms in at least one data record of a body of data records, the method comprising the steps of:
i) selecting a set of one or more search terms; and
ii) referring to the taxonomy to extend the set of one or more selected search terms by including any different search terms having a significant measure of relatedness in relation to the one or more selected search terms.

The method might then further comprise:
iii) searching a plurality of data records by use of the extended set of search terms to produce a results list.

Step ii) may comprise the step of applying a threshold value to select the significant measure of relatedness. In building a search strategy using the taxonomy, this offers a very efficient mechanism for selecting the most highly related search terms.

The body of data records and the plurality of data records might in practice be the same, overlapping or different bodies of data records.

Again, embodiments of the invention in its third aspect can (optionally but not exclusively) be used in recruitment, where the search terms are skill terms. The data records might comprise unstructured documents, having no standard, prescribed format, for example in recruitment these may be any one or more of job advertisements, CVs and/or user profiles.

It may be that there are no different search terms meeting the selection criteria, in which case the “extended” set of search terms will be the same as the originally selected set of search terms.

Preferably, embodiments of the invention in the first and third aspects are combined. In this case, the taxonomy can be updated based on the content of the searched data records, or of a document used in step i). In such a combination, the searched data records or the document might be subjected to the analysis and normalisation steps b) and c), with the addition of a step comprising modifying a taxonomy in accordance with the result. In a taxonomy as described above, modifying the taxonomy might for instance have the effect of modifying one or more clusters of the taxonomy or of adding, deleting and/or substituting search terms in the taxonomy. This combination of embodiments supports updating of the taxonomy in accordance with current usage. Preferably, modification is subject to approval by a user such as a domain expert.

To provide a method for generating a search strategy, the step of selecting a set of one or more search terms might comprise processing an unstructured document to extract search terms therefrom. This can again be done using lexical and optionally heuristic analysis. Further, by applying the analysis and normalisation steps a) and c), and modifying the taxonomy in accordance with the result, this unstructured document may also be used to update the taxonomy.

Embodiments of the invention in a fourth aspect comprise a search engine for searching data records by use of a taxonomy comprising search terms having associated respective metadata wherein, for each search term, the associated metadata includes a measure of relatedness based on co-occurrences of search terms in at least one data record of a body of data records, the search engine comprising:

i) a search term selector for selecting a set of one or more search terms; and

ii) a search strategy formulator configured to access the taxonomy to formulate a search strategy by extending the set of one or more selected search terms by including any different search terms identified by associated metadata as having a significant measure of relatedness in relation to the one or more selected search terms.

The search engine may comprise further components as set out in the claims, and/or configured to provide steps of a method according to embodiments of the invention in its third aspect.

According to embodiments of the invention in a fifth aspect, there is provided a method of ranking a set of search results obtained by searching a body of data records, the set of search results identifying respective data records containing one or more search terms in a first category, the method comprising:

A) selecting at least one search term of a taxonomy, the taxonomy comprising search terms having associated metadata which, for at least some search terms, identifies a second category and includes any positive measure of relatedness to at least one different search term in the second category, the measure of relatedness being based on co-occurrences of the search terms in individual ones of a plurality of data records; and

B) ranking the search results at least partially according to the measure of relatedness to the selected search term(s) of one or more search terms in the second category which are contained in the respective data records of the search results.

The data records might comprise unstructured documents and the step of searching them might comprise analysing them using lexical and/or heuristic analysis. This allows embodiments of the invention to be used where the data records have been created without prescription as to format or content.

The method may further comprise searching data records by use of the taxonomy to generate the search results, the taxonomy comprising search terms in at least the first and second categories, having associated respective metadata which, for each search term, identifies the category and includes a measure of relatedness to at least one different search term, based on co-occurrences of the search terms in individual ones of the plurality of data records. Usually but not necessarily, search terms having positive relatedness values will be in the same category as the term to which they are related.

Embodiments of the invention in this fifth aspect can potentially be used to produce search results in the manner of a known search engine, based on search terms in a first category such as skills, but then to rank them according to correlations associated with search terms in a second category such as company name, the correlations being embedded in the taxonomy and not necessarily known to an operator carrying out a search. For example, a search might find a number of CVs listing front end development as a skill. Embodiments of the invention can then rank the search results using a pattern of relatedness embodied in the taxonomy between search terms in the second category, such as companies worked for. It is not necessary in constructing a search query to know which search terms, such as company names, to use. Instead, the presence of a search term in the second category is interpreted according to the taxonomy by using any pattern of correlation there may be with one or more search terms co-occurring in that second category.

There are often correlations between companies worked for. In an embodiment of the invention in this fifth aspect in the field of recruitment, a company name in a data record in the search results might have a strong correlation as a feeder company to the company carrying out recruitment and this is potentially identified by a measure of relatedness in the metadata of that company name.

Embodiments of the invention in the first and fifth aspects can be combined, the steps a) and b) being carried out so as to identify pairs of search terms in each of the first and second categories, the metadata comprising a measure of relatedness for each co-occurring search term in relation to search terms in its respective category. This means that the ranking of the search results can be entirely data driven, based on any correlation of search terms in the second category that emerges from the analysed body of data records. However, it is preferably an option that an operator such as a domain expert can carry out modifications and/or approval.

Embodiments of the invention in a sixth aspect provide a weighting processor for ranking search results based on search terms in a first category, the search results identifying respective data records, the weighting processor being adapted to:

review the respective data records using a taxonomy comprising search terms in a second category, the search terms having associated metadata which, for each search term in the second category, includes a measure of relatedness to at least one different search term in the second category, based on co-occurrences of the search terms in individual ones of a plurality of data records, and

rank the search results at least partially according to the measure of relatedness of one or more search terms in the second category which are contained in the respective data records of the search results.

A search engine comprising the weighting processor may comprise further components as set out in the claims, and/or configured to provide steps of a method according to embodiments of the invention in its fifth aspect.

According to embodiments of the invention in a seventh aspect, there is provided a method of ranking search results obtained by searching a body of data records, the method comprising:

selecting at least one search term of a taxonomy, the taxonomy comprising search terms having associated metadata which, for each search term, identifies a category and includes any positive measure of relatedness to at least one different search term in the same category, the measure of relatedness being based on co-occurrences of the search terms in individual ones of a plurality of data records;

for each data record of the search results, summing the measures of relatedness of any search terms from the taxonomy present in the data record and having the same category in relation to the selected search term(s); and

ranking the search results at least partially according to the summed measures of relatedness.

The data records might again comprise unstructured documents and the step of searching them might comprise analysing them using lexical and/or heuristic analysis.

Embodiments of the invention in the first and seventh aspects can be combined. Again, this means that the ranking of the search results can be entirely data driven. Embodiments in the third and/or fifth aspects may further be combined.

According to embodiments of the invention in an eighth aspect, there is provided a weighting processor for ranking search results obtained by searching a body of data records,

wherein the weighting processor is adapted to review the search results using one or more selected search terms from a taxonomy, the taxonomy comprising search terms having associated metadata which, for each search term, identifies a category and includes a measure of relatedness to at least one different search term in the same category, based on co-occurrences of the search terms in individual ones of a plurality of data records,

the weighting processor having an input to receive the one or more selected search terms and being adapted to review each data record of the search results by, for each selected search term, summing the measures of relatedness of each different search term of the taxonomy present in the data record, and to rank the search results at least partially according to the summed measures of relatedness for each individual data record of the search results.

It is to be understood that any feature described in relation to any one embodiment or aspect of the invention may be used alone, or in combination with other features described, and may also be used in combination with one or more features of any other of the embodiments or aspects, or any combination of any other of the embodiments or aspects, if appropriate.

A taxonomy-based system according to one or more embodiments of the invention will now be described, by way of example only, with reference to the accompanying drawings in which:

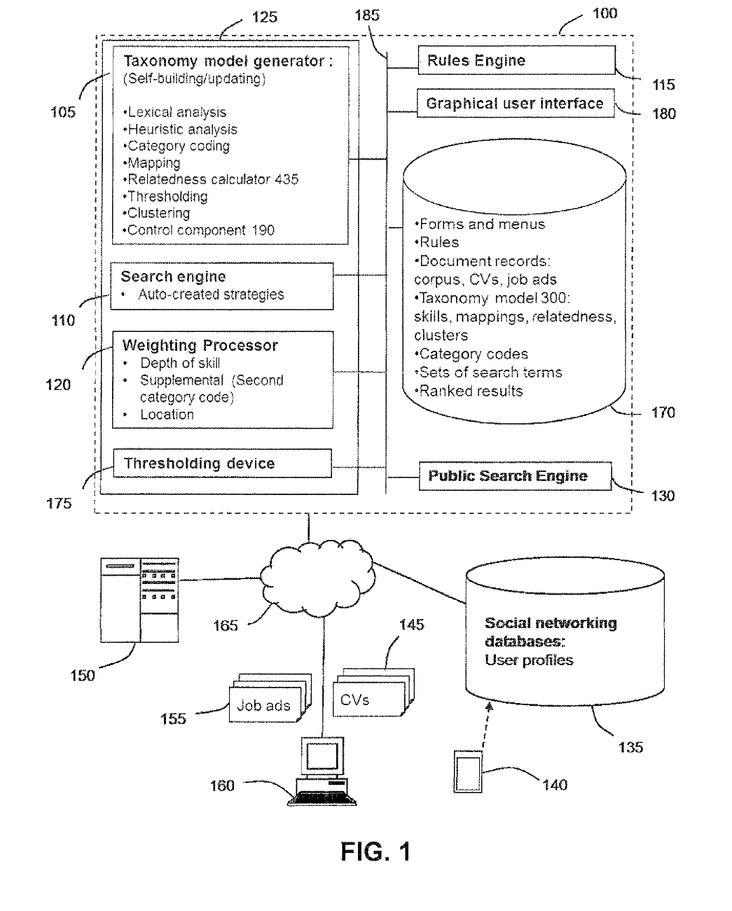

FIG. 1 shows a functional block diagram of the taxonomy-based system;

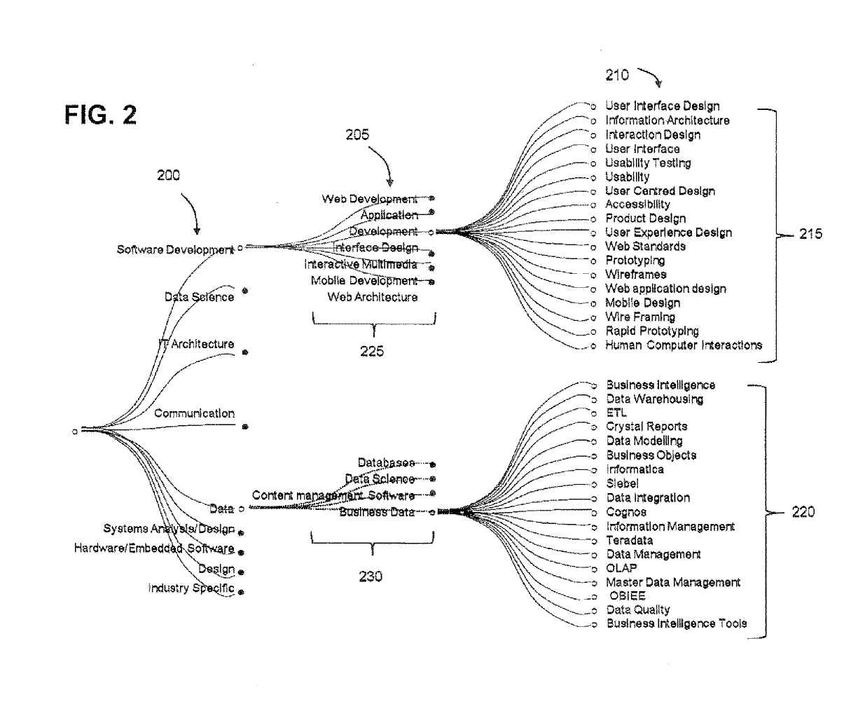

FIG. 2 shows part of a three-layered taxonomy built using the taxonomy-based system;

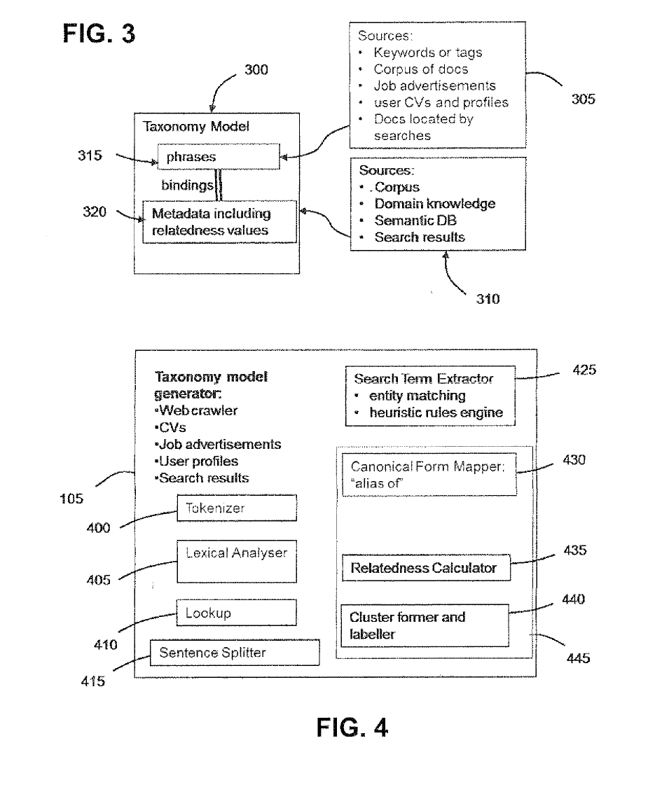

FIG. 3 shows a block diagram of a model and sources for the taxonomy of FIG. 2;

FIG. 4 shows a functional block diagram of components of a taxonomy model generator of FIG. 1;

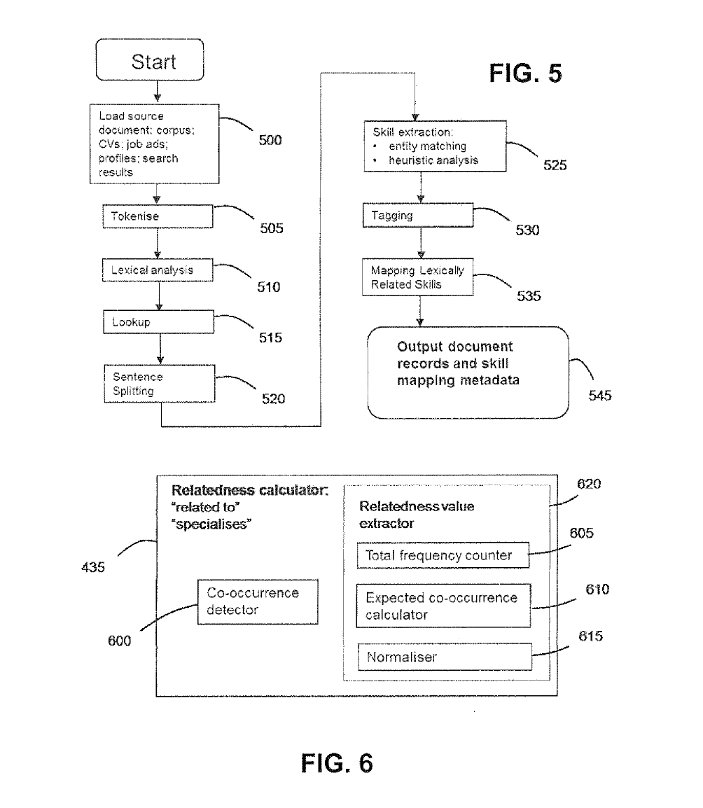

FIG. 5 shows a flow diagram of steps in extracting phrases from unstructured text for the taxonomy of FIG. 2;

FIG. 6 shows a functional block diagram of sub-components of a relatedness measuring component of FIG. 4;

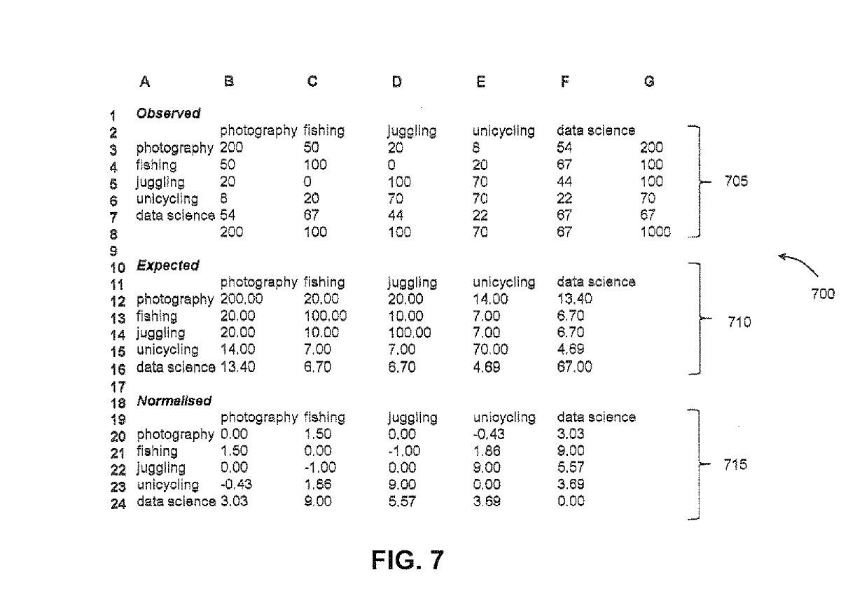

FIG. 7 shows an example in spreadsheet format of data that might be built in deriving relatedness between skill terms in the taxonomy of FIG. 2;

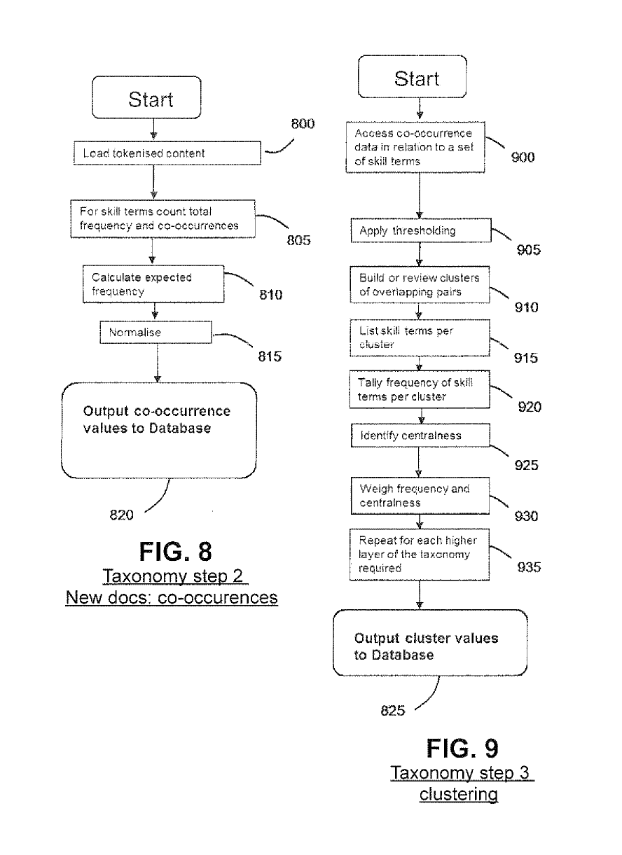

FIG. 8 shows a flow diagram of steps performed by a relatedness measuring component of FIG. 4;

FIG. 9 shows a flow diagram of steps performed by a cluster former and labeller of FIG. 4;

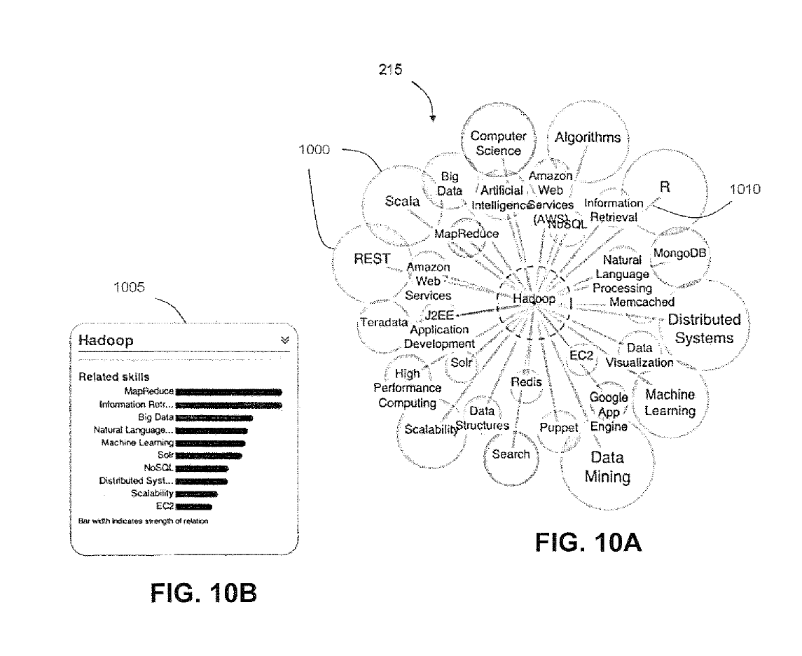

FIG. 10 shows a graphical representation of a cluster formed in building the taxonomy of FIG. 2;

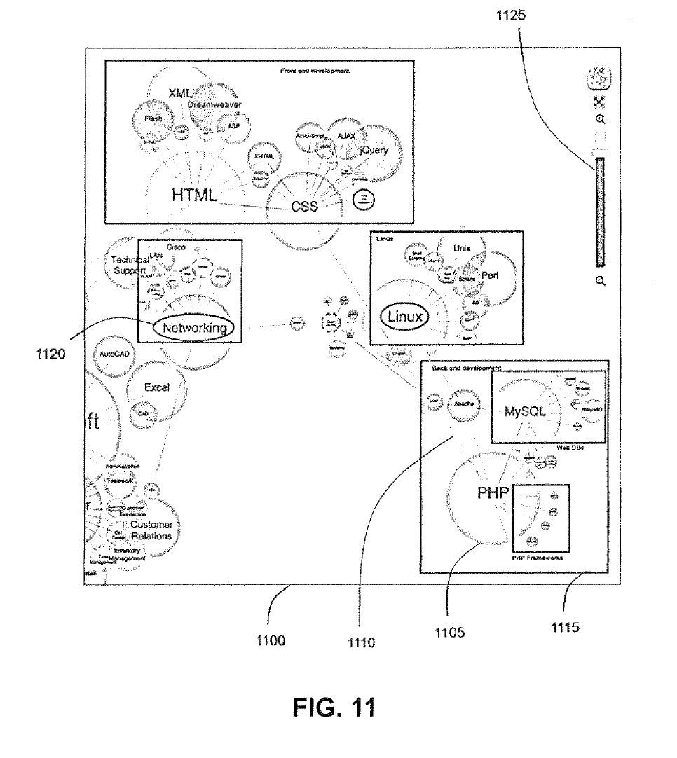

FIG. 11 shows a screen representation of multiple clusters that might be used in selecting cluster size and labels;

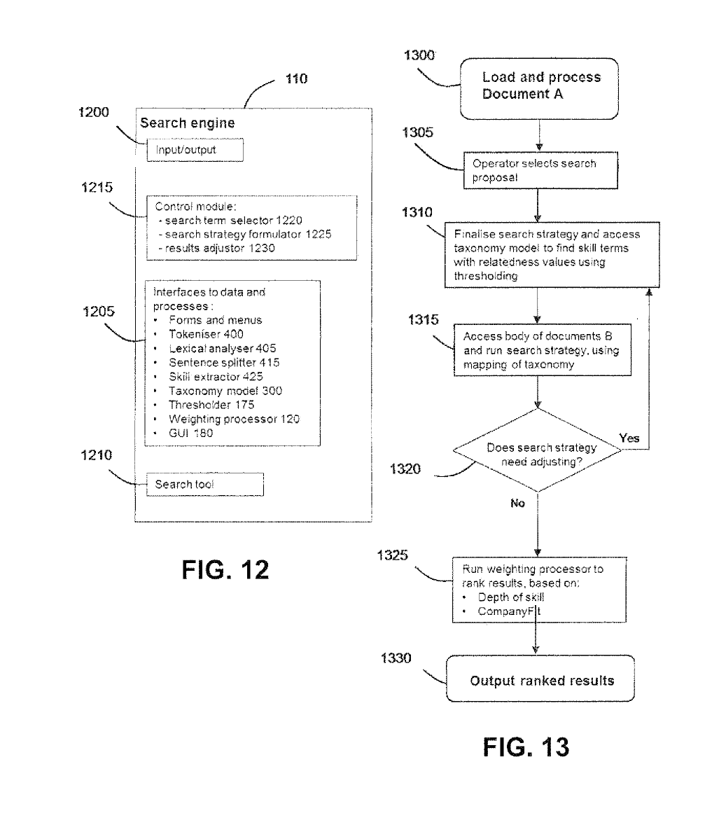

FIG. 12 shows a functional block diagram of sub-components of a search engine of FIG. 1;

FIG. 13 shows a flow diagram of steps involved in generating ranked search results using the search engine of FIG. 12;

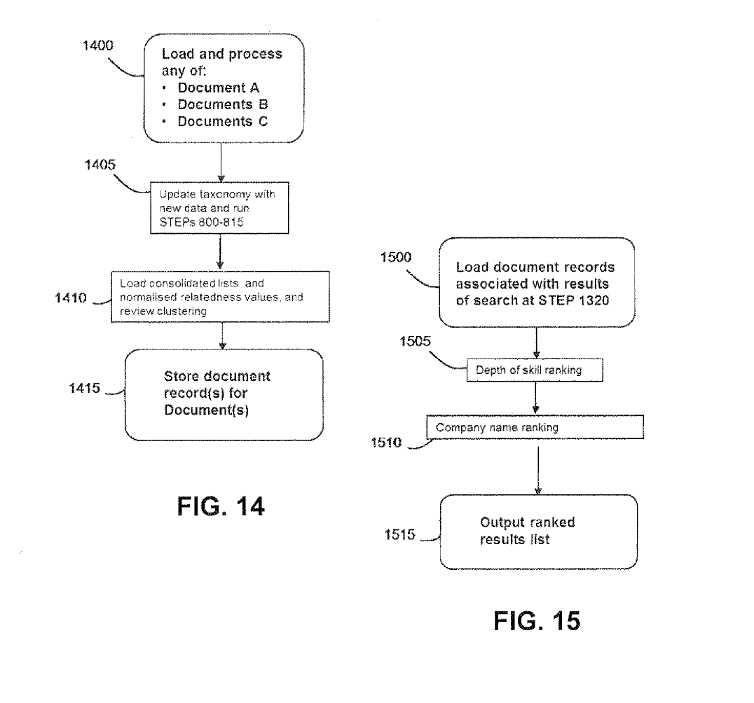

FIG. 14 shows a flow diagram of steps involved in updating the taxonomy of FIG. 2 and other relatedness data stored in the database of FIG. 1; and

FIG. 15 shows a flow diagram of steps involved in weighting search results in the process of FIG. 13.

Referring to FIG. 1, the taxonomy-based system 100 comprises a set of devices 125 for performing operations on unstructured documents. The documents might for instance be accessible over the Internet 165 or stored in a local database 170. The unstructured documents are selected to be job- or skill-related and might include for example job advertisements 155 posted by employers, CVs 145 posted by potential job applicants, and user profiles present on social networking databases 135. The taxonomy-based system 100 has a public search engine 130 of known type, providing browsing capability for accessing and downloading unstructured documents over the Internet 165. The Internet provides connection in known manner to for example storage locations such as social networking databases 135 and servers 150. These storage locations might hold user profiles, job advertisements 155, CVs 145 and other documents which users, who might be prospective employers or employees, have loaded from their smartphones 140 or other computing devices 160. All components of the system 100 are connected to a local network 185 which in turn can connect to the Internet 165.

The system 100 comprises a number of components, processes and data structures and these will be installed for use in known manner on computer processors which may be centralised or distributed across different platforms. Thus use of the components in methods according to embodiments of the invention comprises running a processor to carry out the process. The components themselves might be installed in one or more computer processors for use, or recorded or stored on a data storage medium ready for such installation. The system 100 includes interfaces for interaction with other platforms, including local computing devices and GUIs, databases, social network sites and user equipment connected to the Internet.

The taxonomy-based system 100 comprises four primary processing components, these being a taxonomy model generator 105, a search engine 110 capable of generating search strategies from unstructured documents and running searches, a weighting processor 120 for ranking search results, and a thresholder 175 which plays a key support role to the taxonomy model generator 105 and the search engine 110. The system 100 also comprises a rules engine 115 for implementing processes of the other components and a GUI 180 for use by a system operator.

Overall the taxonomy-based system 100 operates to provide auto-generation of taxonomies and search strategies from unstructured documents. The taxonomies so generated can be at least partially automatically updated by subsequent search results, although this may require the input of an operator such as a domain expert. Search results based on using the search strategies can be ranked using additional information accessible via the Internet.

Taking the general operation of the components in turn, the process of the taxonomy model generator 105 is to extract skill terms from a corpus of unstructured documents, using lexical and heuristic processing, and then to analyse the co-occurrence of skill terms in individual documents to support a clustering algorithm from which a relatively flat taxonomy tree structure can be created. The search engine 110 shares some of the processes of the taxonomy model generator 105 to create a search strategy from potentially a single unstructured document which can then be supplemented or extended by reference to a taxonomy, optionally generated by the taxonomy model generator 105. The weighting processor 120 operates on results of searches output by the search engine 110, both by further analysis of document content and by accessing additional information via the Internet. The thresholder 175 is run in conjunction with both the taxonomy model generator 105 and the search engine 110 in tailoring their output.

Referring to FIG. 2, an example taxonomy for use in recruitment, built using an embodiment of the invention, has three layers 200, 205, 210. A first layer 210 comprises search terms arranged in clusters 215, 220. Just two clusters 215, 220 are shown as examples. The second layer 205 comprises labels for the clusters 215, 220 of the first layer 210, these labels themselves being clustered, again just two clusters 225, 230 being shown as examples. The third layer 200 comprises labels for the clusters of the second layer 205.

Phrases

Referring to FIG. 3, the taxonomy is stored in a database as a model 300 comprising a set of “phrases” 315 bound to respective metadata 320. The phrases provide the search terms and labels of the clusters 215, 220, 225, 230 and the third layer 200 shown in FIG. 2. “Phrases” may comprise one or more words and in the job-related embodiment of the invention described here are skill terms. The metadata 320 include mappings and a measure of relatedness between the skill terms, this being further described below.

The skill terms 315 can be extracted from sources 305 such as documents already identified (as keywords or ‘tags’ for example) and/or can be curated from the raw text of documents using lexical and heuristic analysis such as grammatical cues, frequency analysis and document structure.

Referring to FIG. 4, the taxonomy model generator 105 of FIG. 1 provides components, some of which are of known type, in order to build a clustered list of skill terms. These are:
tokeniser 400
lexical analyser 405
lookup 410
sentence splitter 415
search term extractor 425
canonical form mapper 430
relatedness calculator 435
cluster former and labeller 440

A known example of an information extraction system that provides suitable processes for at least some of the first five components is the open source software known as “GATE”, the General Architecture for Text Engineering. GATE was developed initially at Sheffield University and information about GATE is available http://gate.ac.uk/.

The canonical form mapper 430, relatedness calculator 435, cluster former and labeller 440 all generate metadata in relation to the search terms extracted by the search term extractor 425 and can together be considered a metadata generator 445 that generates the metadata to be bound to the search terms.

There are three primary processes involved in building or updating a taxonomy model. These are described below with particular reference to FIGS. 5, 8 and 9.

Referring to FIG. 5, skill terms 315 and their mapping data are extracted by the skill extractor 425 of FIG. 4 from unstructured documents. To build the taxonomy at least initially, a large corpus of documents is preferable. However, to update the taxonomy model, a smaller number of documents might be used, such as a body of CVs, user profiles or the results of searches. In the process of FIG. 5, the unstructured documents are subjected to the following steps:

STEP 500: the content of the source document is loaded to the taxonomy model generator 105.

STEP 505: the content is tokenised by segmentation in known manner, using a tokeniser 400, the segments being identified according to start and finish character numbers in the content.

STEP 510: the segments are analysed using a lexical analyser 405 to allocate category codes, for instance to indicate a verb, punctuation or possible organisation (such as a company or educational establishment), job title, name or geographical significance. The lexical analyser can be provided with lists and rules in relation to each of these.

STEP 515: (the following step is performed by a process provided by the taxonomy model generator 105 but in practice is used in creating search strategies and running searches as further described below.) Any segment having a category code indicating a possible organisation, job title, name or geographical significance is subjected to a lookup process 410. This matches the relevant segment against a source, such as a list of job title components such as “manager”, of names or organisations or a gazetteer to identify genuine data. This step confirms or removes the possible category code assigned in STEP 510 and might in practice require approval by an operator.

STEP 520: a sentence splitter 415 identifies different sentences.

STEP 525: a skill extractor 425 analyses content of the segments using firstly entity matching against a list of skills to identify segments that contain a known skill. The list of skills might be initially derived for example from a database of skills collected from publicly available sources such as Freebase and DBpedia. Importantly, particularly where the document is of known type and likely to have certain characteristics, the skill extractor 425 can also apply one or more heuristic rules, to sentences and to the document as a whole, to identify new skills. Heuristic rules based for example on specific characteristics of common CV formats have been found effective, such as:
identifying sentences that are mostly enumeration, i.e. a number of short passages separated by commas or in a bulleted list
position in document relative to skill-related content, such as immediately following a heading ‘Skills & Experiences’ or the like
frequency of terms. It has been observed that terms mentioning skills are likely to be more frequent than terms corresponding to places or organisations (e.g. ‘Northampton’, ‘Samsung’) but less frequent than everyday terms (e.g. “able”, “experience”, or “learning”).

These heuristic rules are used to generate a list of possible skill names, ordered by descending frequency, which can be manually inspected and accepted or rejected by an operator. This enables the production of a viable lexicon of skills for new domains such as financial services and energy industries, which can be used in updating the taxonomy model 300 to cover emerging technologies or fields of enterprise.

(It is an option that the functionality of the skill extractor 425 be broadened to extract other entities such as company names by use of additional heuristic rules and an appropriate category code.)

STEP 530: the skill extractor 425 adds a category code such as “SK”.to skills identified in STEP 525 as such, and optionally confirmed by an operator.

STEP 535: a mapper 430 is used to map skills by finding lexically related variants, synonyms or equivalents, and associating these with a canonical form. This mapping generates “alias of” metadata 220 for each term in relation to its canonical form and the canonical form lists all its aliases. This means that starting from a skill term it is possible to identify its canonical form and then the list of aliases for the search term.

Variants are generated for each new skill term using the encoded knowledge of a domain expert in combination with linkage to online semantic databases. They include for example semantic equivalents, synonyms, common misspellings, internationalised versions and alternative forms such as “JavaScript” and “Javascript”. Once variants are established for a skill term, they are each assigned to a single canonical form and the canonical form is formatted to list all the variants assigned to it. For example, “JS” may have been identified as a skill and the mapper 430 would associate JS with its canonical version such as “JavaScript”.

Once approved by an operator via the GUI 180, usually this being by a domain expert, mapping will be incorporated in the metadata 220 for the relevant skill term and is encoded in terms of:
the approval of a skill phrase in canonical form. Any skill must be assigned to either a canonical form or as a synonym for a canonical form
a mapping from variants of a skill phrase to the canonical form where the mapping is unambiguous and a variant can only map to one canonical skill
where one skill phrase is synonymous with another a directional relationship is defined from the variant to the canonical form, this indicating which is the canonical form and which the variant
a canonical skill may additionally list any number of unambiguous aliases. These may include synonyms, internationalised versions or common misspellings

When new skills emerge, one can use known algorithms to suggest likely aliases for a given skill name based on similarity, e.g. low Levenshtein distance; containment of one name within another; whether a phrase is a possible acronym of another, etc. These suggestions are presented to a domain expert for each skill in turn who can accept any of them with a single click and also select one of them as the canonical form. Normally, the aliases with the most occurrences is the canonical form but this still requires human confirmation, for example to expand a colloquial phrase to a formal one, such as expanding “photoshop” to Adobe Photoshop”.

The mapper 430 can also be used to map other categories of search term, such as company names.

STEP 545: a processed document now has considerable data associated with the tokenised content, potentially including category codes for organisations, job titles, names, geographical terms and skill terms. This tokenised content is stored in the system database 170 as a document record. Further, the skill extractor 425 and the mapper 430 produce a list of skill terms, some of which may be new in relation to an existing taxonomy, together with metadata comprising mapping data for lexically related skills to a shared canonical form. The tokenised content, skills list and metadata are output to the database 170 for use with relatedness data extracted as described below with reference to FIGS. 6 to 9 in building or updating a taxonomy model 300 to which they are relevant.

Metadata 220

The relationships between search terms, or skill terms, are defined overall in embodiments of the invention by metadata 220 as follows:
“alias_{—} of”: where A alias_of B specifies that A is semantically equivalent to the canonical form B (and only B), where B lists all variants such as misspellings and alternative forms. “Alias of” metadata is generated by the mapper 430 as described above at STEP 535, using the encoded knowledge of a domain expert in combination with linkage to online semantic databases.
“related_to”: where A related_to B specifies a quantified numeric measure of statistical association. This is generated as described below, from analysis of co-occurrence data between pairs of skill terms.
“specialises”: where A specialises B specifies that A is a special case of B and consequently documents matching A should be included for searches which include B. This is a transitive relation in that if C specialises B and B specialises A then searches for A should return documents matching C. “Specialises” metadata is generated after clustering as described in relation to FIG. 9 below.

Regarding the “alias of” metadata, in subsequent processing skill terms are identified in relation to their single canonical form. The occurrence of any variant listed by that single canonical form is considered an occurrence of the skill term.

The “related_to” form of metadata is based on co-occurrence frequency. The “alias_{—} of” and “specialises” metadata can be suggested by the relatedness metadata but go on to extend it with expert input. It is primarily the “related to” and “specialises” metadata which gives the taxonomy its structure. The “related to” metadata primarily gives inter-search term relationships within and between clusters in the same layer in the taxonomy while the “specialises” metadata is usually most relevant between terms in different layers and supports the hierarchical structure. However the “alias of” and “specialises” metadata both offer relationships (in addition to the “related to” metadata) that can affect search strategies and results. For example, using metadata embodying the “alias of” and “specialises” relatedness measures, the taxonomy can match a document containing search term A to a query specifying search term E if:
A alias_of B, B specialises C, C specialises D, E alias_of D.

In an example, a search for ‘athletics’ would return a document containing ‘long distance running’ since: ‘long distance running’ alias_of ‘long-distance running’, long-distance running′ specialises ‘running’, ‘running’ specialises ‘athletics’, ‘athletics’ alias_of (misspelling) ‘athletics’.

The “related_to” metadata has a useful function in highlighting disparities, for example if two search terms which specialise a third have negative mutual relatedness. This can occur where search terms are ambiguous for example but a domain expert may have overruled the relatedness indicator. A skill name may have two unrelated contexts, e.g. ‘networking’ for business or IT, or the usage of terms has changed significantly over time because of some shift in the industry. “Specialises” metadata, generalising them to a single ‘parent’ skill, is going to return sets of documents that don't have much in common, i.e. they have much less overlap. However, the relatedness metadata should identify the position and allow an operator to resolve it.

Referring to FIG. 6, the relatedness calculator 435 of the taxonomy model generator 105 shown in FIG. 1 provides a co-occurrence detector 600 and a relatedness value extractor 620. The latter provides a total frequency counter 605, an expected co-occurrence calculator 610 and a normaliser 615.

Data available to the relatedness calculator 435, for each document record after the process described above with reference to FIG. 5, comprises tokenised content including category codes for each occurrence of a skill term and other potential search terms such as organisations. A body of document records is processed by the co-occurrence detector 600 and the total frequency counter 605 to generate data which is then further processed by the remaining sub-components. This processing can be done in relation to any category code but as described below is used for processing skill terms and company names. Referring additionally to FIG. 7, the processed data can be used for example for populating a table 700.

Referring additionally to FIG. 8, the process carried out by the relatedness calculator 435 is as follows:

STEP 800: for a body of document records, load tokenised content of each document to the calculator 435 and list each different skill term/company name for the document.

STEP 805 (total frequency and observed co-occurrence): for each document record, detect the presence of each skill term/company name and use the co-occurrence detector 600 to detect co-occurrences of each skill term/company name with each other skill term/company name. The co-occurrence detector 600 operates on each document record by listing each skill term and company name and, for each listed skill term/company name, recording each different skill term/company name occurring in the same document record. Where there is no occurrence of a different skill term/company name, the listed item can be discarded. Having processed a document record, the occurrence of each skill term/company name and the detected co-occurrences are counted by the total frequency counter 605. For the body of document records, populate the first set of values 705 (rows 3 to 7) of the table 700 to show the number of document records in which each skill term/company name is present and also the number of document records in which co-occurrence of each pair is present, specifying the relevant pair. For example, the skill term “juggling” can be seen to have an observed co-occurrence value with “unicycling” of 70 but has a total frequency, this including document records in which it occurs on its own, of 100. The total frequency values here have been copied into a marginal row and column (row 8 and column G).

STEP 810 (expected frequency): the observed numbers of co-occurrences are not an accurate measure of relatedness because skill terms/company names that occur frequently anyway in the corpus of documents will tend to have a higher tally of co-occurrences. It is important to normalise the count values against the frequency expected for the skill term/company name pairs. Therefore the next step is to use the expected co-occurrence calculator 610 to calculate for each pair of skill terms/company names the expected frequency of co-occurrence based only on their observed total frequencies (from row 8 and column G). This gives a second set of values 710 of the table 700 (rows 12 to 16) which shows the expected number of co-occurrences based on term frequency alone.

STEP 815 (normalisation): Using the normaliser 615 to apply the formula:

Actual Relatedness=(Observed−Expected)/Expected

calculate the actual relatedness values to be incorporated in the metadata for the skill terms/company names, this providing the third set of values 715 of the table (rows 20-24). Taking an example, juggling and unicycling for example, which are of similar nature, have a positive normalised value of 9.00, indicating actual relatedness and it is this relatedness value that is used in the metadata for the pair of skill terms in the taxonomy model 300. Other search terms such as company names may simply be listed in the database 170 with their metadata, including their relatedness values, rather than being included in the taxonomy model 300.

The mechanism described here is of known type and generally describes the generation of a signed residual value for the Pearson contribution to the CHÎ2 test.

Although frequency is recorded for terms occurring alone in a document, if a term does not co-occur in any document, it is not processed for relatedness since its co-occurrence frequency is implicitly zero.

The above process is directly measurable from analysis of skill term/company name occurrence in documents. Referring to FIGS. 2, 9 and 10, the next steps in building the taxonomy are to use the cluster former and labeller 440 of FIG. 4 to cluster and to label the skill terms/company names based on their relatedness. Once clusters 215, 220 are created, this gives the first layer 210 of the taxonomy. The next step is to label the clusters 215, 220 to give the second layer 205. Depending on the depth of taxonomy required, or the overall number of skill terms/company names for inclusion, the clustering and labelling process can be carried out again in relation to the labels of the second layer 205, arriving at a third layer 200.

FIG. 9 shows the following steps of a clustering process, here described mainly for skill terms but at least partially applicable to other category codes such as company names:

STEP 900: load skill terms, company names and normalised relatedness values output by the relatedness calculator 435.

STEP 905 (thresholding): set a threshold value that can filter out skill terms or company names having lower relatedness values from subsequent search queries or clustering processes. Threshold values for relatedness can be set on-the-fly in several processes of the taxonomy-based system 100 for the purpose of controlling the number of selected items, including for example when selecting search strategies, further described below. In relation to FIGS. 9 and 10, it can be used to control the number of skill terms that are selected for clustering and therefore the cluster sizes. Depending on the threshold relatedness value chosen, this can mean that only skill terms which have a significant relatedness value in relation to one or more other search terms will be clustered.

STEP 910 (clustering): use a known clustering algorithm, such as that known as “Chinese Whispers”, to create clusters of skill terms each having at least one relatedness value which meets the threshold value set in STEP 905.

STEP 915: list the different skill terms in each cluster 215, 220, this giving the first layer 210 of the taxonomy.

STEP 920: for each skill term listed in STEP 915, refer to the total frequency (row 8 and column G of FIG. 7).

STEP 925: for each skill term in a single cluster, calculate the total of the positive normalised relatedness values it has with other skill terms in the same cluster, this giving a measure of “centralness”. For example, this gives the values 9.00, 10.86 and 1.86 for juggling, unicycling and fishing respectively. (Repeat for each cluster.)

STEP 930: rank the skill terms of each cluster according to one or both of their total frequency and centralness and select the top-ranking skill term as a label for that cluster. For example, frequency and centralness might be summed and weighted individually. Using the terms juggling, unicycling and fishing, without weighting, the summed values are 109.00, 80.86 and 101.86, indicating that juggling might be marginally the best label. (In practice, this is not a good example as a broader term such as “circus skill” is very likely to have appeared in the cluster and to have had a high normalised relatedness value to each of juggling and unicycling and thus a significantly higher “centralness” value.)

An alternative approach is to use the measure of centralness to rank the terms in a cluster and to use frequency only to separate terms having similar centralness. For example, a potential label might be selected by reviewing the skills which each have their most related skill within the same cluster and then selecting one of these based on frequency. FIG. 10 shows a visualisation of a single cluster 215 from the first layer 210 of the taxonomy, this being further described below.

Subject to confirmation by an operator such as a domain expert, each selected label might be used to create “Specialises” metadata for each term in its cluster.

STEP 935: taking all the labels generated at STEP 930 as skill terms in the second layer 205 of the taxonomy, cluster these. To cluster these labels, it is possible to assess the inter-cluster relatedness (for instance between skill terms from one cluster to another of the clusters in the first layer 210 that the labels relate to), in order to obtain a measure of relatedness for clustering the labels of the second layer 205. For example, Wikipedia describes agglomerative clustering of this type in relation to hierarchical clustering.

Referring to FIG. 11, either to supplement the labelling process described above at STEPs 930 and 935, or in place of it, it is possible to use an interactive process via the GUI 180, based on a relatedness graph 1100 and controlled by an operator such as a domain expert. In FIG. 11, an iterative, force-directed algorithm of known type has been used to arrange search terms in the graph 1100 according to their relatedness. An example of such an algorithm can be seen at: http://bl.ocks.org/mbostock/4062045. Skill terms are shown as circles 1105 whose areas are dependent on the total frequency of the relevant term (row 8 and column G of FIG. 7) linked by edges 1110 denoting relatedness. Clusters have not yet been selected. The operator, potentially a domain expert, can traverse the graph, marking up possible clusters and representative labels directly, on screen, using markup tools such as rectangles 1115 for selecting possible clusters and ovals 1120 for indicating a possible cluster label. An approach that can be used for selecting labels might for instance be along the lines of Exemplar theory which can be seen at: http://en.wikipedia.org/wiki/Exemplar_theory.

It might be noted that thresholding on the edges 1110 showing relatedness values can be controlled here by the operator, via a scroll bar 1125. This has the effect of changing the number of edges 1110 displayed and can expose the structure of the graph 1100 more clearly.

A graph such as that shown in FIG. 11 might also use colour to indicate a further grouping, amongst the search terms. For example, a relatively small number of broad top level labels may already have been approved, such as “software development” or “design” and the search terms assigned at that top level. This assignment might be shown by colour coding the circles 1105.

At the end of the process of FIG. 9 and optionally FIG. 11, considerable metadata has been generated for each skill term of a taxonomy. This is stored as a document record for each skill term, using in this case a MongoDB database. A typical example of this metadata in JSON is as follows:

{″_id″:{″$id″:″51bede90f7c3a23645000179″},
″count″:2708,
″isa″:″skill″,
″name″:{″canonical″:″MongoDB″,″popular″:″MongoDB″,“aliases”:[“mongo”,
“mungodb”]},
″pathToTop″:{″name″:″Data″,″children″:[{″name″:″Databases″,″children″:[{″name″:
Nonrelational Databases″,″children″:[{″name″:″MongoDB″}]}]}]},
″rank″:378,
″related″: <see below>,
″relation″:[{″type″:″extends″,″target″:″5215d87a8b660fc77ced1ee1″}],
″semantic″:{″freebase″:″/en/mongodb″},
″status″:{″active″:″true″,″review″:″approved″},
″id″:″51bede90f7c3a23645000179″}

An example of the content for “related” is:

[{name:Redis, strength:109},
{name:NoSQL, strength:71.5},
{name:Node.js, strength:66.375},
{name:Backbone.js, strength:43.75},
{name:Memcached, strength:41.25},
{name:Solr, strength:36},
{name:Nginx, strength:34.6}] ......................

This document record for the skill MongoDB, which is also the canonical form in this case, contains information as follows:
total frequency count 2708, this ranking 378 amongst all skills
alias of “mongo” and “mungodb”
related to “Redis” (relatedness value 109), “NoSQL” (relatedness value 71.5), etc
specialises “Nonrelational Databases” and also “Databases” and “Data” via “pathToTop”
additional metadata is available at http://freebase.com/en/mongodb

FIG. 10 shows a useful visualisation of a single cluster 215 of search terms from the first layer 210 of the taxonomy, all of which are related to Hadoop which has been identified in STEP 330 as the label for the cluster 215 because it is a good exemplar of the cluster. Hadoop will therefore be included in the second layer 205 and undergo the clustering STEP 335. The visualisations shown in FIGS. 10 and 11 can be used by an operator via the graphical user interface 180 in manipulating single or multiple clusters and search strategies. Skill terms 1000 are represented by circles and the area of each circle represents the total number of occurrences of the relevant skill term. Relatedness is indicated by the edges 1010 linking circles to the label Hadoop and the degree of relatedness is shown quantitatively in this visualisation as a bar chart 1005.

As mentioned above, a further relationship is that of specialisation, where one skill term is a specialisation of another skill term, often in the same cluster, such as for example “diving” as a specialisation of “swimming”. This type of relatedness might be added to the metadata of the taxonomy by expert inspection of pairs of members of a cluster using a visualisation such as that of FIG. 10. Any search strategy including “swimming” is then potentially extended to find data records including only “diving”.

Thresholding

The thresholder 175 is a process which can be run on any set of entities present in the taxonomy and having a measure of relatedness. It is embodied in the interface to the taxonomy model 300. Any query to the model 300 can include a relatedness value which will filter out terms in the model having a relatedness value that is below it. It can therefore be operated by the search engine 110 in proposing a search strategy and by any visualisation tool using data from the taxonomy model 300 to create a screen view on the graphical user interface 180, for instance of the type shown in FIGS. 10 and 11, so that an operator can see directly for example changes in the size of clusters 215, 220 of the taxonomy 300 dependent on operation of the thresholder 175, and changes in the entities included in a search strategy. Setting a high relatedness threshold can have the effect of reducing the size of the clusters and/or the relatedness between terms and can lead to clusters which are unrelated to any other cluster. Such clusters can be useful in producing effective search strategies from just one or two suggested search terms. A low threshold on the other hand would make visible search terms that have only low relatedness and may not otherwise appear in a visualisation.

Operation of the thresholder 175 will usually be controlled by an operator input in relation to a screen visualisation of one or more clusters or skill terms for example.

The input might be qualitative or quantitative, for example moving a screen-based cursor or inputting a value.

Thresholding can allow an operator to modify cluster sizes. As seen in a visualisation showing multiple clusters, thresholding can have a different effect on cluster size in different clusters. Search terms of one cluster might be highly related and thus none might be disregarded by thresholding while in another cluster the search terms are only slightly related and the cluster might be highly reduced by thresholding. In a search operation, thresholding can similarly be used to modify the complexity of a search strategy based on the taxonomy, as further described below.

Search Engine 110 and Strategies

Having created a taxonomy as described above, using a large corpus of documents, the search engine 110 can develop a search strategy which requires relatively little or no domain knowledge. A search strategy can be created automatically either from one or more suggested search terms or from a source document, perhaps a job advertisement or a job application form, by identifying search terms present in the document using the lexical and heuristic analysis described with reference to FIG. 5, and then extracting related search terms from the taxonomy based on the identified skill terms. Search terms extracted in this way provide a search strategy that can generate “hits” amongst a body of documents which do not necessarily contain any of the originally suggested or identified search terms but do contain extracted search terms and are still potentially of high relevance. For example, a job advertisement can be processed which mentions business data and this would be identified as a skill term by the lexical analysis. Referring to FIG. 2, business data is a cluster label in the second layer 205 of the example taxonomy. Using the skill term “business data” to extract related terms from the taxonomy can produce a search strategy including all the search terms of the cluster 220 associated with that label and using that search strategy in searching a body of job applicants' CVs would potentially for example locate an applicant who had mentioned OLAP and OBIEE but not business data.

Use of the thresholder 175 can of course modify the number of extracted terms and therefore the search strategy selected. It may be for instance that an identified skill term has a high level of relatedness to another skill term in the same layer of the taxonomy. For example, “juggling” and “unicycling” might be strongly related in a cluster having the label “performance”. The step of extracting terms from the taxonomy based on “juggling” might include thresholding according to a relatedness value so that the extracted terms include “unicycling” from the same cluster.

The search engine 110 can make search strategies available in different ways. A suggested search query can be automatically extended or the most highly related terms suggested to the operator via the GUI 180, say the top ten. Alternatively a search query entry process can be formatted to request whether the search query should be extended in a selectable manner, for instance to include terms related by specialisation or otherwise.

Referring to FIG. 12, the search engine 110 comprises an input/output 1200 for search queries and results which can be formatted as form, menu or text inputs and graphical visualisations or data outputs for display and interaction with a user. Importantly, the search engine 110 has interfaces 1205 for running components of the taxonomy model generator 105 on an unstructured input document or document record. These components, such as the tokeniser 400, lexical analyser 405, sentence splitter 415 and skill extractor 425, can extract potential search terms from an unstructured document which can be used to build a search strategy based on the potential search terms via the taxonomy model 300. The search engine 110 also has a search tool 1210 based on a known type, such as Lucene/SOLR, for running search strategies in relation to documents once a strategy is approved by an operator. All the processes/components of the search engine 110 are run and co-ordinated by a control module 1215.

The control module 1215 of the search engine 110 provides a search term selector 1220 to a user via the input/output 1200 by delivering forms or menus stored in the database 170 and receiving inputs of the user. This can be used to establish a search proposal which can then be finalised. The control module 1215 also provides a search strategy formulator 1225 and a results adjustor 1230. The search strategy formulator 1225 allows the operator to make the choices as to how the search strategy is to be finalised, for example by either automatic extension to highly related search terms or by ranked lists of potential search terms that the operator can select amongst. The search strategy formulator 1225 then co-ordinates access to the taxonomy model 300 via the thresholder 175, using the search proposal. The results adjustor 1230 allows the operator to review the results, to select the number and presentation and/or to rerun the search if necessary with a different search strategy and/or parameters.

Referring to FIG. 13, operation of the search engine 110 in creating and running a search strategy for use in recruitment, from an unstructured source document A, is as follows:

STEP 1300: load an unstructured document A and use the interfaces 1205 to run at least STEPS 500-530 described above to produce a partial document record comprising one or more lists of search terms in one or more different respective categories, such as skills and company names.

STEP 1305: an operator uses the search term selector 1220 to select a search proposal from the lists of search terms, for instance using a menu and/or form input. This may be simply one or more of the lists of search terms.

STEP 1310: the operator uses the search strategy formulator 1225 to select a final search strategy including parameters dictating how the search proposal is extended and how results should be weighted. For example, the search proposal might be automatically extended to highly related search terms or the operator might prefer to select from ranked lists of potential search terms. Results might be weighted according to depth of skill and/or company history. The search strategy formulator 1225 accesses the taxonomy model 300 with regard to the search proposal from STEP 1305 to find different search terms in each category, as required for the strategy parameters selected by the operator. The different search terms, whether skill terms or company names, have positive relatedness values in relation to those listed and/or a “specialises” relationship. Add these different search terms to provide a candidate strategy to the operator. The operator might then apply the thresholding mechanism 175 (via the search strategy formulator 1225) on the relatedness values to finalise a search strategy.

STEP 1315: use the search tool 1210 to search a body of documents B, using the finalised search strategy and mapped alternatives having the same canonical form together with search terms identified as “alias of” from the taxonomy, to obtain a results list for the body of documents B.

STEP 1320: use the results adjustor 1230 to review the results list. Is the results list of a reasonable size and were the search parameters correct? For example, if there are no company names, weighting by company history is not appropriate. If not, adjust the thresholding of STEP 1310 or search parameters and repeat STEP 1315 as necessary. If yes, finalise results list.

STEP 1325: run the weighting processor 120 to rank the results.

STEP 1330: output the results to storage, the GUI and/or to a remote network location.

Updating the Taxonomy

It is an important feature of embodiments of the invention that the taxonomy can be updated from unstructured documents. These can be documents against which a search strategy is run (Document A above), documents searched using the search strategy (body of documents B above) and/or a freshly selected body of documents C. To build or update the taxonomy, the taxonomy model generator 105, acting as a taxonomy building component, has a control component 190 which co-ordinates the process. Referring to FIG. 14, the ability to update from unstructured documents means that the process of searching can automatically update the taxonomy where a document on which a search is based, or a body of documents processed in the search, includes at least some which have not been previously processed in relation to an existing taxonomy. New phrases are added to the taxonomy but updating requires a recomputation of relatedness between new and existing search terms. This generally will leave existing “alias_of” and “specialise” relations in place but will require recomputing for all the “related to” values. A recalculation of relatedness is appropriate whenever frequency statistics are likely to have changed. This might be from either new skill terms being identified as above or when documents have been added or removed from an original source body, causing possible frequencies to be changed for all skill terms.

Referring to FIG. 14, an update process co-ordinated by the control component 190 is as follows:

STEP 1400: load and process one or more unstructured documents. This might be done by extending either of STEPs 1300 or 1315 above to encompass all of STEPs 500 to 545 or by loading and processing a fresh set of documents according to STEPs 500 to 545. The result is document records comprising tokenised content, segments having assigned category codes indicating a company name (output of STEPs 510, 515), a list of skill terms and metadata comprising mapping data for lexically related skills to a shared canonical form.

STEP 1405: add any new skills, company names and mapping metadata to taxonomy data and run STEPs 800 to 815 to give consolidated lists, mapping metadata, figures for total frequency, observed co-occurrence and normalised relatedness values.

STEP 1410: load consolidated lists of skill terms, company names and normalised relatedness values to the taxonomy 300 and run STEPs 905, 910 to confirm or set a relatedness value threshold in relation to skill terms and review resultant clustering. New skill terms might now appear and the operator can identify if there is a need to adjust clustering, for example because a new group of skill terms has arisen that has no or very limited relatedness to an existing cluster, or just to add a new skill term and possibly approve a “specialises” relationship.

STEP 1415: store the document records for the documents loaded in STEP 1400.

Weighting Processor 120

As described above, the search engine 110 can propose a search strategy based on relatedness values between search terms. This can be tailored by applying different category codes so that a search strategy contains skill terms or company names or any other entity having a category code and relatedness values. This facility can be used for weighting search results by identifying relatedness values in the same manner as for skill terms and looking for relatedness patterns in the document records of the search result.

Various supplemental category codes might provide data that contributes to ranking, these including for example company names. An important factor in recruitment can be employment history in that different companies have different cultures. Where an individual works, or has moved between companies, these are likely to appear in that individual's CV or user profile and can be reviewed against co-occurrence data.

To weight search results taking account of these additional factors, the processes described above in relation to FIGS. 5, 7, 8 and 9 can produce relatedness data for each category code of interest. It should be noted here that establishing relatedness data can be biased by the source documents. It will generally be preferred where skill terms are concerned to use as large a corpus of documents as possible. Where other category codes are concerned this may not be the case. Thus to establish relatedness amongst company names for use in weighting search results for a vacancy in a firm, the source documents for establishing relatedness patterns might be employment records of current employees of that firm.

Having established relatedness values for a category code such as company names, these are listed in the database 170. It is then possible to extract sets of company names with above average relatedness values, optionally using the thresholder 175 to control the size of the sets. These sets can then be used to weight search results based on document records of the individuals concerned. Thus an individual's CV and/or user profile might contain instances of three different company names. In a weighting exercise, these might be used as search terms to identify if any one or more has a high relatedness value in relation to a company undergoing a recruitment exercise. The weighting processor 120 will rank the search results accordingly.

A further factor in weighting search results in the case of recruitment is to review the “depth of skill” of the individuals under consideration. The system 100 offers a way to assess the depth of experience candidates have more effectively than a recruiter might be able to. It is known simply to scan a CV to see how many times a skill such as PHP is mentioned. Embodiments of the invention are able to pick up a range of different PHP-related skills someone has—if their CV, their social media engagement, their social networking profiles or past experience indicate that they have worked with PHP in a wide variety of ways or in senior positions then the system 100 can recognise this and give them a higher ranking.

Referring to FIG. 15, the process of STEP 1325 can be expanded as follows:

STEP 1500: load the document records associated with results finalised at STEP 1320.

STEP 1505: for each document record, refer to the taxonomy to identify different skill terms listed in the document record and appearing in a selected cluster of the taxonomy. Assign a “depth of skill” ranking value based on the number of skill terms listed for that cluster. This might be modified, for example by summing the relatedness values of all the skills listed in the document record in relation to a selected target skill, for example (but not necessarily) a label of a selected cluster.

STEP 1510: for each document record, refer to the set of search terms stored in the database 170 having the category code indicating company name. For each company name listed in the document record, identify the relatedness value (if any) to a target company name, potentially the name of a company carrying out recruitment. Assign a “company name” ranking value, for example the total of all identified relatedness values.

STEP 1515: output ranked results list.

1. A method of building a taxonomy by associating metadata with search terms, wherein the method comprises the steps of:
a) analysing a body of data records to identify pairs of search terms co-occurring in individual data records and to obtain an observed measure of the frequency of such co-occurrences between identified pairs; and
b) building a taxonomy by constructing metadata and associating the search terms with respective metadata, the metadata for each co-occurring search term identifying at least one other search term with which it co-occurs, together with a measure of relatedness based on the observed co-occurrence frequency measure between the co-occurring pair.

2. A method according to claim 1 wherein the body of data records comprises unstructured documents.

3. A method according to claim 1 wherein the step of analysing the body of data records includes lexical and/or heuristic analysis.

4. A method according to claim 1 wherein the construction of metadata in step b) comprises:
c) normalising the observed co-occurrence frequency measure with respect to an expected frequency measure, based on overall frequency of occurrence of the respective search terms, to obtain the measure of relatedness.

5. A method according to claim 1 wherein the step of building the taxonomy comprises:
d) building at least two clusters of search terms, each search term in a cluster having a non-zero measure of relatedness to at least one other search term in the cluster;
e) labelling the clusters; and
f) using the search terms from the clusters to create a first layer of the taxonomy and using the labels of the clusters to create a second layer.

6. A method according to claim 1 wherein each measure of the frequency of co-occurrences is the number of data records in which there is co-occurrence.

7. A method according to claim 4 wherein the overall frequency of occurrence is the number of data records in which a search term occurs.

8. A method of searching a body of data records comprising the use of a taxonomy built according to claim 1, in combination with a search engine to search a body of data records.

9. A method according to claim 8 further comprising the step of updating the taxonomy using the searched body of data records.

10. A method according to claim 1, further comprising the step of applying a threshold value for the measure of relatedness such that search terms having only co-occurrences for which the measure of relatedness is below the threshold value are disregarded.

11. A method according to claim 5, wherein the step of labelling the clusters comprises using the search term in a cluster that most frequently occurs in the body of data records.

12. A method according to claim 5, wherein the step of labelling the clusters comprises responding to an input via a user interface to add, choose or modify a label.

13. A method according to claim 1 wherein the step of analysing the body of data records comprises lexical analysis of the body of data records so as to achieve a canonical form for each search term, to which variations can be related.

14. A method according to claim 13 wherein the step of lexical analysis comprises identifying search terms in different categories and allocating a category code to each search term, the method further comprising for at least two categories identifying pairs of search terms co-occurring in individual data records and obtaining a measure of related ness between identified pairs.

15. A system for building a taxonomy comprising metadata associated with search terms, wherein the system comprises:
a) a co-occurrence detector for analysing a body of data records to identify pairs of search terms co-occurring in individual data records and to obtain an observed measure of the frequency of such co-occurrences between identified pairs; and
b) a relatedness value extractor for creating associated metadata for each co-occurring search term identified by the co-occurrence detector, the metadata identifying at least one other search term with which it co-occurs, together with a measure of relatedness based on the observed co-occurrence frequency measure between the co-occurring pair.

16. A system according to claim 15, wherein the relatedness value extractor comprises a normaliser configured to normalise the observed co-occurrence frequency measure with respect to an expected frequency measure, based on overall frequency of occurrence of the respective search terms, to obtain the measure of relatedness.
